(19) United States
(12) Patent Application Publication
(10) Pub. No.: US 2021/0048050 A1
(43) Pub. Date: Feb. 18, 2021

(54) PROTECTION DEVICE FOR CABLE TIES AND METHOD OF USE

(71) Applicant: Tyler Daniel Coey, Kansas City, KS (US)

(72) Inventor: Tyler Daniel Coey, Kansas City, KS (US)

(21) Appl. No.: 16/994,977

(22) Filed: Aug. 17, 2020

Related U.S. Application Data
(60) Provisional application No. 62/887,497, filed on Aug. 15, 2019.
(60) Provisional application No. 62/957,032, filed on Jan. 3, 2020.

(51) Int. Cl. F16B 2/08; F16M 13/02

(52) U.S. Cl. CPC F16B 2/08; F16M 13/022

(57) ABSTRACT

A protective sleeve for use with common cable ties. Preferred embodiments would be formed from silicone rubber to provide flexibility and grip around the cable tie and for thermal protection of the tie as well as cushioned protection of objects secured by the tie. The protective device adds grip to the cable tie as it secures an object, along with aesthetic enhancements through color options and a more finished look. In addition to protecting the cable tie from temperature, it is also protected from UV light, fungus, staining, and corrosion from exterior elements.

### CROSS-REFERENCE TO RELATED APPLICATION

This application claims priority in U.S. Provisional Patent Application No. 62/887,497 filed Aug. 15, 2019, and in U.S. Provisional Patent Application No. 62/957,032 filed Jan. 3, 2020, both of which are incorporated herein by reference.

### BACKGROUND OF THE INVENTION

### 1. Field of the Invention

The present invention relates generally to a protection device and method for use thereof, and more specifically to a silicone rubber sleeve sized specifically for cable (also referred to as “Zip”) ties to add protection and grip.

### 2. Description of the Related Art

Cable ties, commonly referred to as “hose ties” or “zip ties,” are commonly used to secure cables, wires, or for securing or organizing other objects. The cable tie has a tip that is inserted through a head that has a pawl to form a ratchet so that the tip is pulled through the head and tightens as the zipper elements pass through the pawl, preventing the tip from thereafter being removed from the head.

Cable ties are generally formed from relatively inexpensive, semi-hard plastics with generally rough edges and corners. These can cause damage to objects that are secured using the cable tie. The plastic is often a displeasing color aesthetically and may be prone to corrosion, staining, and damage due to weather and temperature fluctuations. What is needed is a way to improve the look and life of common cable ties.

Heretofore there has not been available a system or method for a protection device for cable ties with the advantages and features of the present invention.

### BRIEF SUMMARY OF THE INVENTION

The present invention generally provides a protective sleeve for use with common cable ties. Preferred embodiments would be formed from silicone rubber to provide flexibility and grip around the cable tie and for thermal protection of the tie as well as cushioned protection of objects secured by the tie. The protective device adds grip to the cable tie as it secures an object, along with aesthetic enhancements through color options and a more finished look. In addition to protecting the cable tie from temperature, it is also protected from UV light, fungus, staining, and corrosion from exterior elements.

### BRIEF DESCRIPTION OF THE DRAWINGS

The drawings constitute a part of this specification and include exemplary embodiments of the present invention illustrating various objects and features thereof.

FIG. 1 is a three-dimensional isometric view of a protective cover device as an embodiment of the present invention.

FIG. 2 is a front elevational view thereof showing an open end.

FIG. 3 is a three-dimensional isometric view of a cable tie being inserted into an open end thereof.

FIG. 4 is a side elevational view diagramming steps used in practicing an embodiment of the present invention.

FIG. 5 is a three-dimensional view thereof showing the head of the cable tie extending out of an end of the protective cover device.

FIG. 6 is a three-dimensional view showing the cable tie extending out of the end of the protective cover device.

FIG. 7 is a side elevational view diagramming the closure of the cable tie.

FIG. 8 is a side elevational view thereof showing a clipped end of the cable tie.

FIG. 9 is a front elevational view of the protective cover device and showing a top plan view, bottom plan view, right side elevational view, and left side elevational view thereof on respective sides of the protective cover device.

FIG. 10 is a three-dimensional view showing a preferred embodiment of the present invention in a typical environment securing a first object to a second object.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. Preferred Embodiment Cable Tie Protector System 2

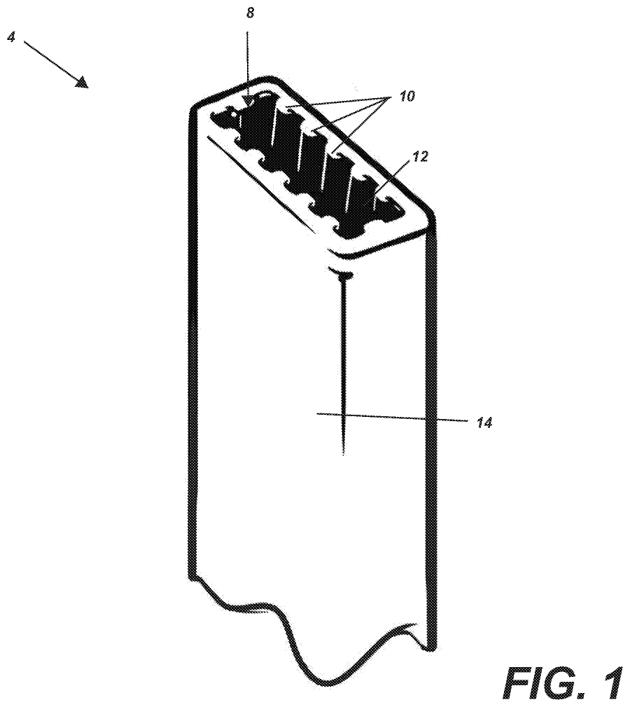

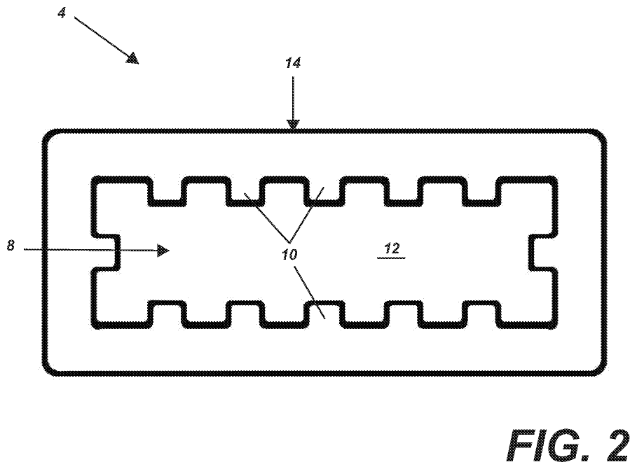

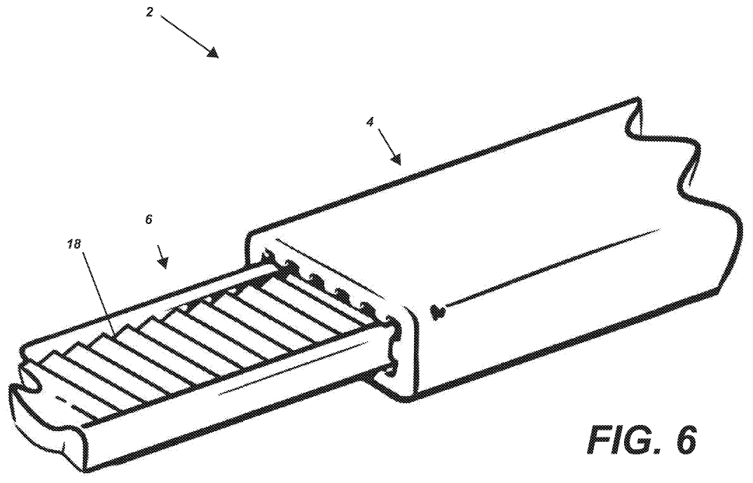

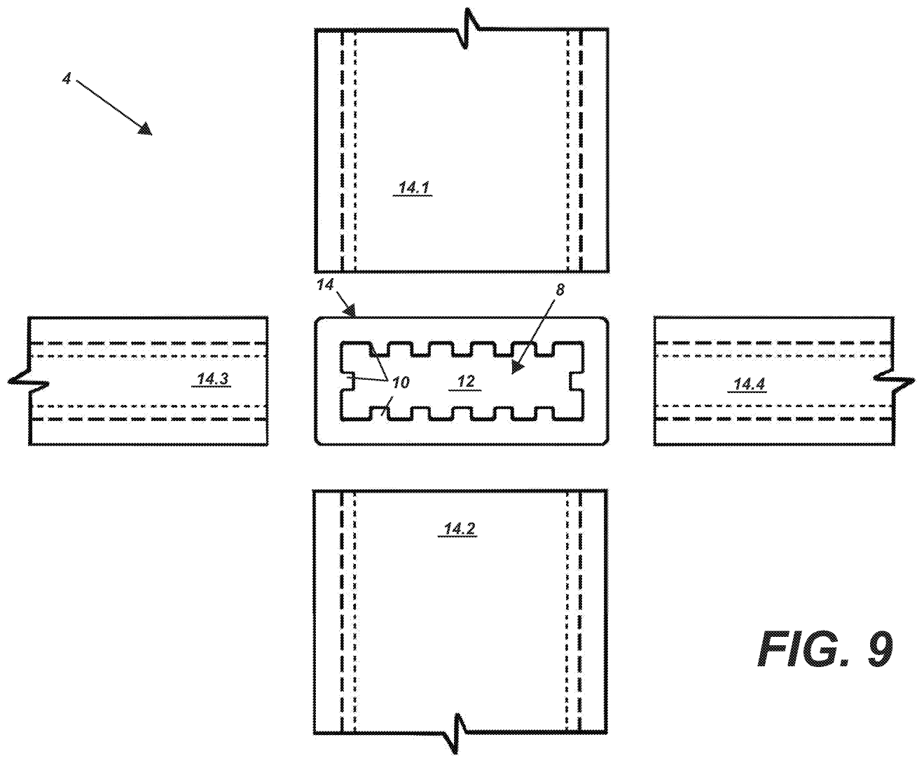

As shown in FIGS. 1-9, the present invention provides a protective sleeve 4 for use with cable ties 6. FIG. 1 shows an end of the protective sleeve 4 which as an opening 8. A corresponding opening 8 would be present at the other end of the sleeve 4. An exterior surface 14 of the sleeve provides protection of the cable tie 6 that is inserted through the sleeve, and may include colors for marking what is being secured by the cable tie 6 or for aesthetic purposes. The interior 12 of the sleeve 4 may include interior treads 10 to remove friction and drag when installing the cable tie 6 into the sleeve 4. Exterior treads (not shown) may also be present on the exterior surface 14 of the sleeve.

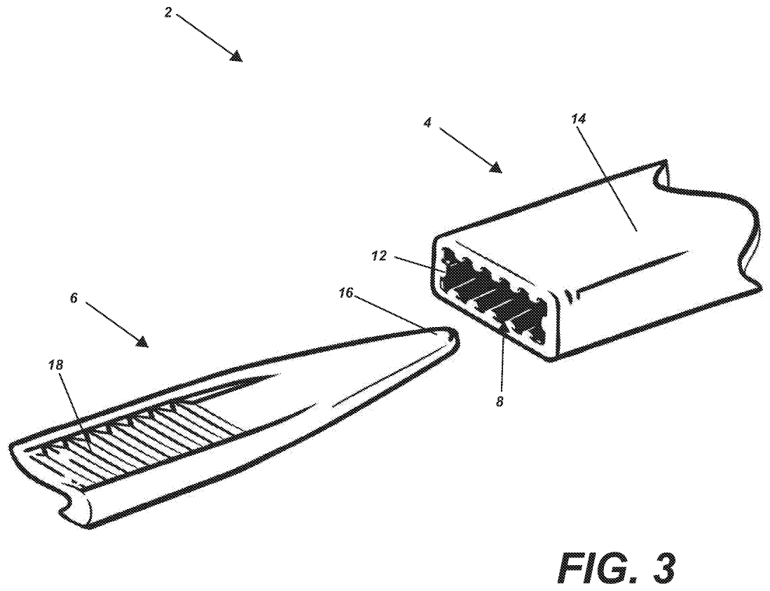

FIG. 3 shows a tip 16 of the cable tie 6 being inserted into the opening 8 of the end of the sleeve 4. The zipper surface 18 of the cable tie is also shown.

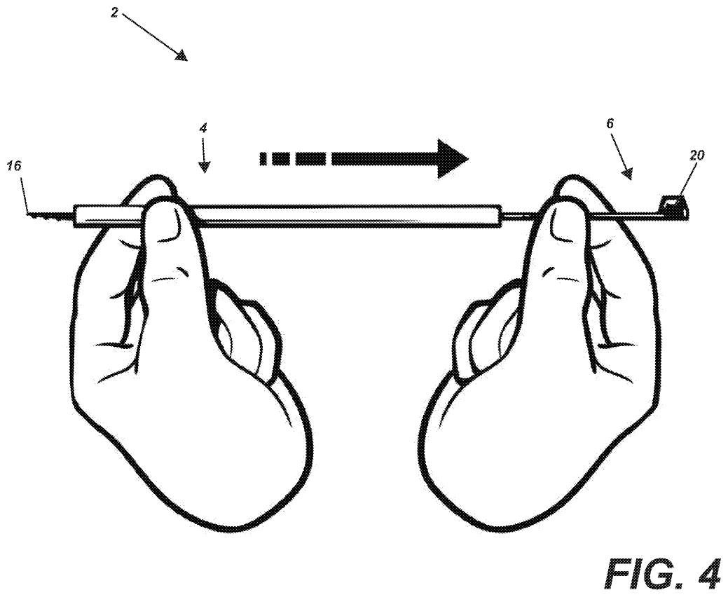

FIG. 4 shows the sleeve 4 fully inserted onto the cable tie 6 such that the tip 16 of the cable tie extends out of one end of the sleeve 4, while the head 20 of the cable tie 6 extends out from the other end of the sleeve 4.

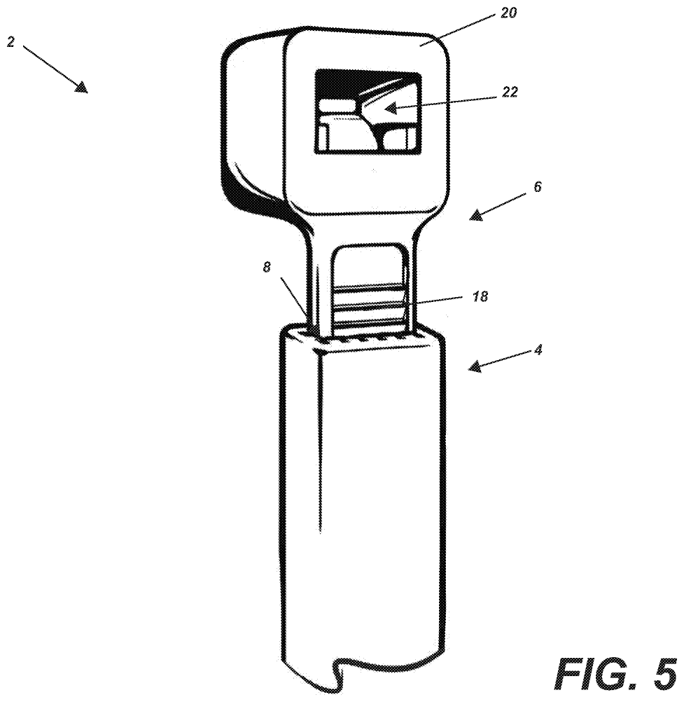

FIG. 5 shows the head 20 of the cable tie 6 extending out of the opening 8 of an end of the sleeve 4. The head includes an opening 22 which receives the tip 16 of the cable tie 6 and has a pawl which functions as a ratchet when the cable tie zipper surface 18 passes through the pawl.

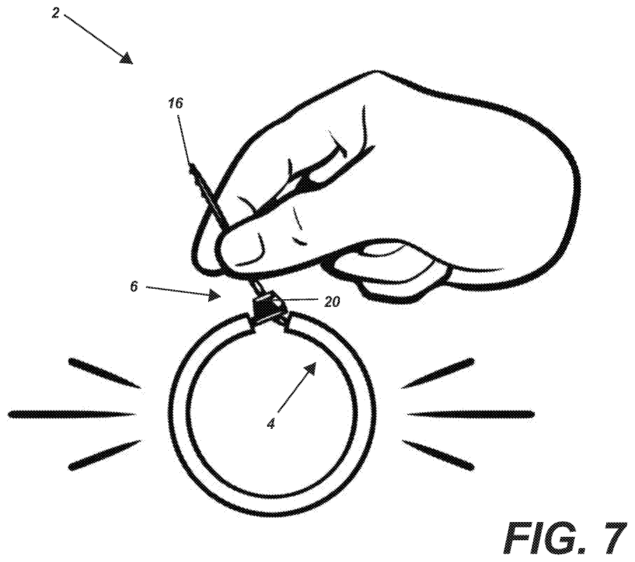

FIG. 7 shows the cable tie 6 secured by passing the tip 16 through the head 20 and closing the cable tie 6. The sleeve 4 forms a full enclosure of whatever is being secured by the cable tie, and fully encompasses the entire cable tie 6 except for the head 20 and the portion of the cable tie 6 which has passed through the head 20.

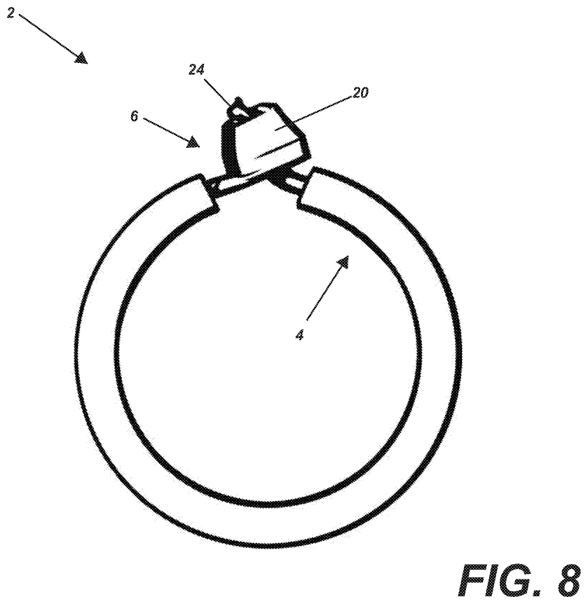

FIG. 8 shows the cable tie 6 after the tip 16 and portion of the cable tie 6 that has passed through the head 20 have been clipped off, forming a clipped end 24.

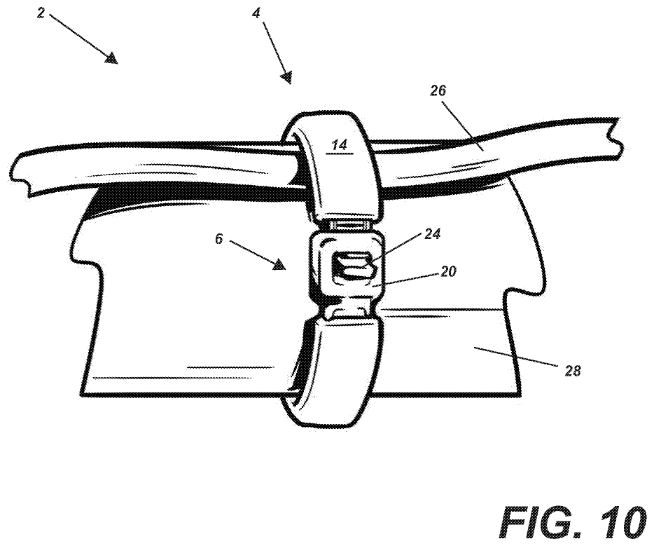

FIG. 10 shows the cable tie 6 and sleeve 4 assembled as above and securing a first object 26 (herein shown as a wire) to a second object 28 (herein shown as a pole or conduit). As above, when secured using the sleeve 4 installed on the cable tie 6, the secured object 26 is protected from rubbing from the harsh edges of the cable tie, is more securely held in place by the frictional exterior 14 of the sleeve 4, and may be identified by a color or pattern applied to the sleeve 4.

As shown, the user will take the sleeve 4 and measure it to size so that it will be able to fully enclosed whatever object 26 is being secured by the cable tie 6. The sleeve 4 may be cut if necessary. Once sized properly, the sleeve 4 is slipped over the cable tie 6 by inserting the tip 16 of the cable tie 6 into an opening 8 of an end of the sleeve 4. The interior treads 10 allow the sleeve 4 to smoothly slip over the cable tie 6 with minimal friction. The sleeve 4 is pulled all the way to the head 20 of the cable tie, and then the cable tie is secured about an object 26 by inserting the tip 16 of the tie 6 through the head 20, and pulling a portion of the cable tie through the head, wrapping the cable tie and sleeve around the object 26 to be secured, after which the tip 16 and portion of the cable tie passed through the head 20 are clipped off.

Thereafter the sleeve 4 acts to protect the secured object 26 from the harsh edges of the cable tie 6, while also protecting the cable tie 6 from external threats such as weather, temperature, sunlight, corrosion, fungus, and staining for long-lasting use of the cable tie with the aesthetic improvements afforded by the sleeve 4.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A cable tie protection system comprising:
a sleeve having a first end with a first opening, a second end with a second opening, an interior space passing from said first opening to said second opening, and an exterior surface;
said sleeve configured to be slipped over a cable tie by inserting a tip of said cable tie into said first opening, through said interior, and out of said second opening; and
wherein said sleeve thereby protects said cable tie from external threats.

2. The system of claim 1, further comprising a plurality of internal ridges located within said interior space of said sleeve, said plurality of internal ridges configured to reduce friction between said sleeve and said cable tie.

3. The system of claim 1, wherein said sleeve comprises a color.

4. The system of claim 1, wherein said sleeve is comprised of silicone rubber.

5. The system of claim 1, wherein said sleeve provides frictional grip against an object secured by said cable tie and said sleeve.

6. A method of protecting a cable tie, the method comprising the steps:
inserting a tip of a cable tie into a first end of a sleeve;
passing said tip of said cable tie through an interior space of said sleeve and out a second end of said sleeve;
sliding said sleeve along said cable tie until said first end of said sleeve contacts a head of said cable tie;
wrapping said cable tie and said sleeve about an object to be secured; and
inserting said tip of said cable tie through said head and securing said cable tie and said sleeve about said object by pulling said tip of said cable tie and a portion of said cable tie through said head.

7. The method of claim 6, further comprising the steps:
determining a length of said sleeve; and
cutting said sleeve to said length.

8. The method of claim 6, further comprising the step of removing said portion of said cable tie, including said tip of said cable tie.

9. The method of claim 6, wherein said sleeve comprises a plurality of internal ridges located within said interior space of said sleeve, said plurality of internal ridges configured to reduce friction between said sleeve and said cable tie.

10. The method of claim 6, wherein said sleeve comprises a color.

11. The method of claim 6, wherein said sleeve is comprised of silicone rubber.

12. The method of claim 6, wherein said sleeve provides frictional grip against an object secured by said cable tie and said sleeve.
